(19) United States
(12) Patent Application Publication
(10) Pub. No.: US 2017/0098888 A1
(43) Pub. Date: Apr. 6, 2017

(54) FLEXIBLE CONFORMABLE ANTENNA ARRAY APPLIQUE

(71) Applicant: GM Global Technology Operations LLC, Detroit, MI (US)

(72) Inventors: Kevin Geary, Santa Monica, CA (US); Hyok Jae Song, Oak Park, CA (US); Pan Hsuanyu, Los Angeles, CA (US); Hasan Sharifi, Agoura Hills, CA (US); James H. Schaffner, Chatsworth, CA (US); Arthur Bekaryan, Northridge, CA (US); Igal Bilik, Rehovot (IL)

(21) Appl. No.: 14/876,107

(22) Filed: Oct. 6, 2015

(51) Int. Cl. H01Q 1/32; H01Q 1/38

(52) U.S. Cl. CPC H01Q 1/32; H01Q 1/38

(57) ABSTRACT

A system and a method of coupling radiating elements to a structure are described. The system includes a structure including a fascia, an antenna applique to be disposed conformally behind the fascia, and an adhesion layer between the antenna applique and the fascia.

### FIELD OF THE INVENTION

The subject invention relates to a flexible conformable antenna array applique.

### BACKGROUND

In some radar applications, the space occupied by typical radar antennas can present issues. Current antennas are fabricated on non-flexible, non-transparent printed circuit boards with separate surface mount components. The radar sensors require large mounting brackets and take up space behind the fascia of a vehicle (e.g., the bumper), for example. For example, in an automotive application, high angular resolution is necessary for active safety features and other applications of the radar sensors. However, high angular resolution requires a large sensor array with a physically large aperture and a large number of sensors. Accordingly, it is desirable to provide a flexible conformable antenna applique that provides the needed aperture while complying with space constraints.

### SUMMARY OF THE INVENTION

According to an exemplary embodiment, a system includes a structure including a fascia; an antenna applique configured to be disposed conformally behind the fascia; and an adhesion layer between the antenna applique and the fascia.

According to another exemplary embodiment, a method of coupling radiating elements to a structure includes fabricating an antenna applique; forming an adhesion layer on a first side of the antenna applique; and disposing the antenna applique with the first side being closest to an inside surface of a fascia of the structure.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 shows an antenna applique mounted on a curved surface according to an exemplary embodiment;

FIG. 2 shows an antenna applique mounted on a flat surface according to another exemplary embodiment;

FIG. 3 shows an antenna applique according to an exemplary embodiment;

FIG. 4 depicts a system that includes an antenna applique according to an exemplary embodiment; and

FIG. 5 depicts a system that includes antenna appliques according to another exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

Embodiments discussed herein relate to applique antennas that overcome the space and mounting constraints noted above. The appliques according to the exemplary embodiments conform directly to both flat and curved surfaces. While a vehicle (e.g., automobile) is discussed as an exemplary component or structure using the flexible conformable antenna array applique for explanatory purposes, embodiments discussed herein apply, as well, to other vehicles (e.g., farm vehicles, construction vehicles) as well as non-vehicle components (e.g., consumer electronics, appliances, other transportation systems, manufacturing systems).

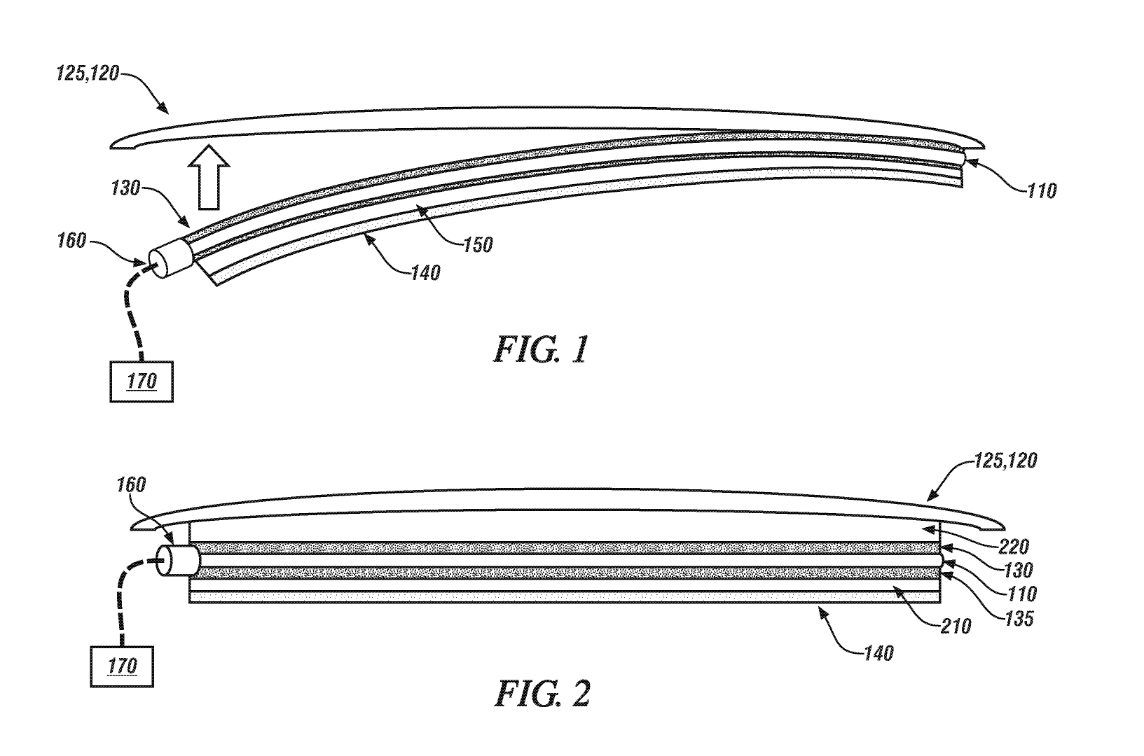

In accordance with an exemplary embodiment of the invention, FIG. 1 shows an antenna applique 110 mounted onto a curved surface 120. As further embodiments discussed herein indicate, one or more antenna appliques 110 may be mounted to or adhered to any fascia 125. The exemplary conformal antenna applique 110 includes passive radar components (e.g., transmission lines, power splitters/combiners including Wilkinson power combiners, radiating elements). The embodiments detailed herein do not address the active components (gain, amplifier, phase shifter). The exemplary embodiment relates to an automobile application and the curved surface 120 in FIG. 1 is window glass, for example. Exemplary glass curved surfaces 120 in the exemplary automobile application include the windshield or headlight assemblies. Other exemplary curved surfaces 120 include door panels, the hood, front bumper fascia, back bumper fascia, the fenders, or trunk.

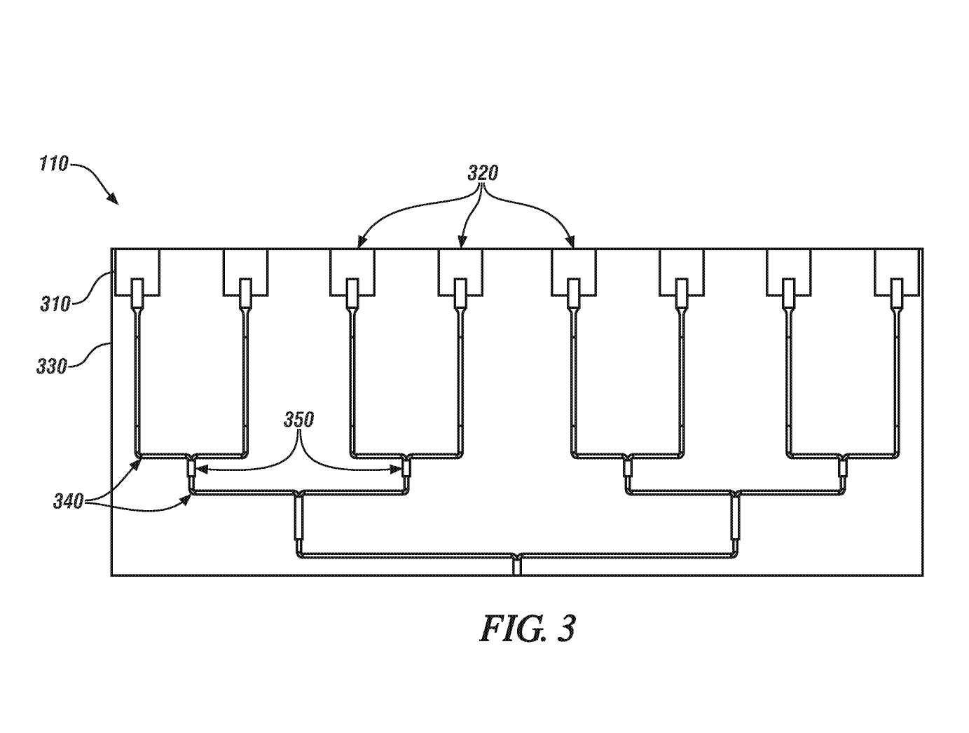

In other applications, the flexible antenna array 320 (FIG. 3) integrated with electronics (taken together as the antenna applique 110) could be mounted onto a different curved surface 120. An adhesion layer 130 may be used to adhere the antenna applique 110 to the curved surface 120 (as indicated by the arrow). A substrate spacer layer 150 may separate the antenna applique 110 from a ground plane 140. The ground plane 140 may be aluminum, a spray-on silver nanowire film, or any other electrically conductive surface. The antenna applique 110 may be formed on a substrate 330 (FIG. 3) such as a polyimide substrate, which is flexible and exhibits good high frequency properties (e.g., low dielectric loss tangent). The polyimide material can withstand large variations in temperature and humidity, which makes the material suitable for applications such as the exemplary automobile application. In alternate embodiments, the antenna applique 110 substrate 330 may be a liquid crystal polymer (LCP), Parylene-C, Parylene-N, polyethylene terephthalate (PET), or polyethylene naphthalate.

A radio frequency (RF) connector 160 is used to couple the antenna applique 110 to electronics hardware 170 that may be remotely located from the curved surface 120 (fascia 125). In the specific example of an automobile application, the RF energy may be centered around 24 gigahertz (GHz) or 77 GHz, for example. For example, the RF energy may be 76 to 81 GHz. In other applications using the antenna applique 110, a different RF frequency may be targeted. The targeted frequency may affect the number of metal layers 310 (FIG. 3) patterned into the antenna radiating structures of the flexible antenna applique 110. In addition to being conformal, the antenna applique 110 may additionally reduce weight and cost based on the manufacturing process facilitated by the design. For example, high-volume roll-to-roll manufacturing is facilitated by the use of the polyimide for the antenna applique 110, for example. Installation time may be reduced and mechanical survivability may be increased over that of rigid electronics, as well.

In accordance with another exemplary embodiment, FIG. 2 shows an antenna applique 110 mounted on a flat surface (despite ultimately being mounted to a curved fascia 125). While the fascia 125 or other surface that the antenna applique 110 is adhered to may be flat in alternate embodiments, the surface (fascia 125) is a curved surface 120 in the embodiment shown in FIG. 2, as it was in the embodiment shown in FIG. 1. A flat surface (a one-dimensional cylindrical curvature) is created for adhesion of the antenna applique 110, according to the present embodiment, by using a foam spacer 220 as an interface or mapping between the curved surface 120 (arbitrary two-dimensional curvature) and the antenna applique 110. Specifically, as shown in FIG. 2, the antenna applique 110 is adhered, using an adhesion layer 130, to a flat side of the foam spacer 220. The antenna applique 110 is wrapped around the one-dimensional cylindrical curvature of the foam spacer 220. The foam spacer 220 may be a polymethacrylimide foam, for example. The opposite surface of the foam spacer 220 is shaped to conform to the shape of the curved surface 120. The antenna applique 110 is also adhered by a second adhesion layer 135 to a second foam spacer 210 formed on the ground plane 140. The spacers 150 (FIG. 1), 210, 220 may all be the same or may be different materials that serve as spacers. The use of the foam spacer 220 to facilitate flat mounting of the antenna applique 110 may facilitate easier mounting of roll-to-roll processed polyimide sheets used in the antenna applique 110.

FIG. 3 shows an antenna applique 110 according to an exemplary embodiment. As noted above, the targeted frequency may affect the number of metal layers 310 patterned into the antenna radiating elements 320 of the flexible antenna applique 110. These metal layers 310 may be comprised of copper, gold, nickel-gold, or other metals for example. Passive combining circuitry may be formed on one metal layer and radiating antenna elements (320) may be formed on another layer within the antenna applique 110. The passive elements include transmission lines 340 and power splitters/combiners 350, in addition to the radiating elements 320. The radiating elements 320 are patch antenna arrays in the exemplary embodiment of FIG. 3. Specifically, a 1×8 patch antenna array applique 110 is shown.

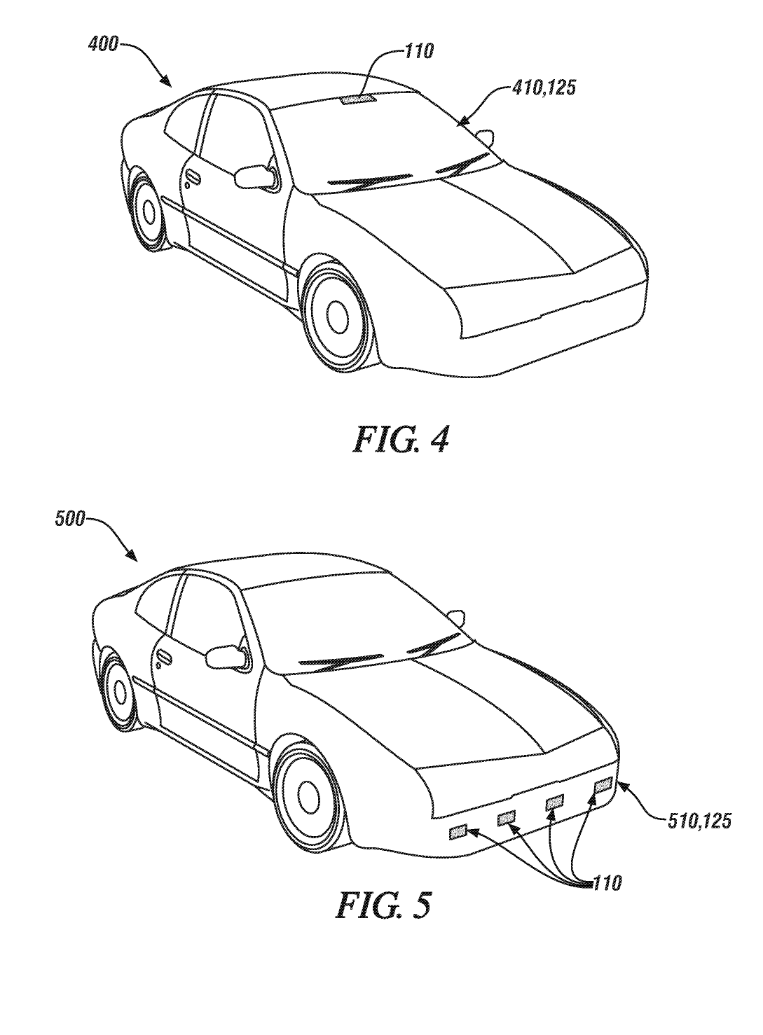

FIG. 4 depicts a system 400 that includes an antenna applique 110 according to an exemplary embodiment. The exemplary system 400 shown in FIG. 4 is an automobile, and the antenna applique 110 is disposed behind the windshield 410 (fascia 125). FIG. 5 depicts a system 500 that includes antenna appliques 110 according to another exemplary embodiment. The exemplary system 500 is an automobile, and four antenna appliques 110 are disposed behind a bumper 510 (fascia 125). In alternate embodiments, the antenna applique 110 could be disposed (adhered) behind any fascia 125 (e.g., headlight assembly, bumper, fender, hood) to protect the antenna applique 110 from the environment. The particular fascia 125 may be selected according to preferred styling, for example.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. A system, comprising:
a structure including a fascia;
an antenna applique configured to be disposed conformally behind the fascia;
a shaped spacer configured to have a flat surface on a side closest to the antenna applique and a surface conforming to the fascia on a side closest to the fascia, the shaped spacer being disposed between the fascia and the antenna applique;
an adhesion layer between a first side of the antenna applique and the shaped spacer; and
a second adhesion layer between a second side of the antenna applique and a second spacer formed on a ground plane, wherein the second side of the antenna applique is opposite the first side of the antenna applique.

2. The system according to claim 1, wherein the structure is an automobile.

3. The system according to claim 2, wherein the fascia is a windshield, fender, or bumper of the automobile.

4. The system according to claim 1, wherein the antenna applique comprises a substrate and metal layers patterned on the substrate into antenna radiating elements.

5. The system according to claim 4, wherein the substrate comprises polyimide.

6. The system according to claim 4, wherein the substrate comprises a liquid crystal polymer (LCP), Parylene-C, Parylene-N, polyethylene terephthalate (PET), or polyethylene naphthalate.

7. The system according to claim 4, wherein the metal layers comprise gold, copper, or nickel-gold.

8. (canceled)

9. The system according to claim 1, wherein a frequency of operation of the antenna applique is between 22 gigahertz and 29 gigahertz.

10. The system according to claim 1, wherein a frequency of operation of the antenna applique is between 76 gigahertz and 81 gigahertz.

11-12. (canceled)

13. A method of coupling radiating elements to a structure, the method comprising:
fabricating an antenna applique;
forming an adhesion layer on a first side of the antenna applique;
disposing the antenna applique with the first side being closest to an inside surface of a fascia of the structure;
disposing a shaped spacer between the antenna applique and the inside surface, the shaped spacer conforming to a shape of the inside surface on a side closest to the fascia and having a flat surface on a side closest to the first side of the antenna applique;
forming a second adhesion layer on a second side of the antenna applique opposite the first side of the antenna applique; and
disposing a second spacer formed on a ground plane such that the second spacer is between the second adhesion layer and the ground plane.

14. The method according to claim 13, wherein the structure is an automobile, and the disposing the antenna applique includes disposing the first side closest to an inside of a windshield of the automobile.

15. The method according to claim 13, wherein the fabricating the antenna applique includes patterning metal layers into antenna radiating elements on a substrate.

16-20. (canceled)
